(19) United States
(12) Patent Application Publication
(10) Pub. No.: US 2024/0263950 A1
(43) Pub. Date: Aug. 8, 2024

(54) PEDESTRIAN DEVICE AND POSITIONING METHOD FOR SAME

(71) Applicant: Panasonic Holdings Corporation, Osaka (JP)

(72) Inventors: Tsuyoshi UENO, Kanagawa (JP); Yoichi NAKAGAWA, Tokyo (JP); Yangping SHEN, Fukuoka (JP)

(73) Assignee: Panasonic Holdings Corporation, Osaka (JP)

(21) Appl. No.: 18/565,904

(22) PCT Filed: May 25, 2022
(86) PCT No.: PCT/JP2022/021411

§ 371 Date: Nov. 30, 2023

(30) Foreign Application Priority Data
Jun. 2, 2021 (JP) 2021-092883

(51) Int. Cl. G01C 21/30; G06T 7/246; G06T 7/73; G08G 1/16; H04N 23/698; H04N 23/90

(52) U.S. Cl. CPC G01C 21/30; G06T 7/246; G06T 7/74; G08G 1/166; G06T 2207/10016; H04N 23/698; H04N 23/90

(57) ABSTRACT

A pedestrian terminal includes: a camera for producing a pedestrian's underfoot images and surrounding view images; a memory for storing ground information including position data and a ground image of each preset record point, and fixture information including feature data and position data of a fixture in a surrounding view image at each record point; and a processor for performing provisional positioning of the pedestrian based on feature data matching between stored feature data of a fixture and that of an object in a captured surrounding view image, to thereby extract ground images of nearby record points as candidates, comparing a candidate with a captured underfoot image for matching, and when a matching ground image to the underfoot image is found, acquires position data of the corresponding record point as the pedestrian's position data.

### TECHNICAL FIELD

The present invention relates to a pedestrian device that is carried by a pedestrian and performs a positioning operation to acquire position data of the pedestrian, and a positioning method for the same.

### BACKGROUND ART

In safe driving assistance wireless systems, an in-vehicle terminal is mounted on a vehicle, and in-vehicle terminals in different vehicles perform ITS communications (vehicle-to-vehicle communications) with each other to exchange position data of the vehicles, thereby preventing occurrence of an accident therebetween. In addition, an in-vehicle terminal and a pedestrian terminal carried by a pedestrian perform TS communications (vehicle-to-pedestrian communications) with each other to exchange their position data, thereby preventing occurrence of an accident between the vehicle and the pedestrian.

Such an in-vehicle terminal and a pedestrian terminal often use satellite positioning to acquire position data of the vehicle and the pedestrian, but a terminal may use any other positioning method, such as PDR (Pedestrian Dead Reckoning). In any case, use of a positioning method that can achieve highly accurate positioning is necessary to ensure prevention of traffic accidents.

In known image-based positioning methods, a camera captures an image of a surrounding view of a vehicle or a pedestrian and a captured image (i.e., an image captured by a camera) is used as a basis for positioning of the vehicle or the pedestrian. In some cases, such a positioning method involves detecting white lines on the road surface based on captured images, and recognizing a traveling lane in which a vehicle is moving, thereby acquiring position data of the vehicle, (see Patent Documents 1 to 3). Another known method involves acquiring a captured image of a front field of view of a vehicle, detecting a landmark object in the captured image (e.g., building near the road), and positioning the vehicle based on the landmark object in the captured image.

### PRIOR ART DOCUMENT(S)

### Patent Document(s)

Patent Document 1: JP2754871B
Patent Document 2: JP3333223B
Patent Document 3: JPH06-149360A

### SUMMARY OF THE INVENTION

### Task to be Accomplished by the Invention

In the case of positioning of a pedestrian, sudden changes in a moving speed and a moving direction of the pedestrian can occur more often compared to the cases of positioning of non-pedestrian subjects such as vehicles. For this reason, when the above-described methods of the prior art are used as they are, highly accurate positioning of a pedestrian often cannot be achieved. Moreover, when camera-captured images of road surfaces are used for positioning of a pedestrian, positioning can be desirably performed with a reduced data processing load on a data processing device.

The present invention has been made in view of these problems of the prior art, and a primary object of the present invention is to provide a pedestrian device and a positioning method that enable positioning of a pedestrian by using camera-captured images of road surfaces on which the pedestrian moves, with a reduced data processing load on a data processing device.

### Means to Accomplish the Task

An aspect of the present invention provides a pedestrian device comprising: a downward camera for capturing images of road surfaces under a foot of a pedestrian, thereby sequentially producing underfoot images; a lateral view camera for capturing images of at least one of a front field of view, a right field of view, a left field of view, and a rear field of view of the pedestrian, thereby sequentially producing surrounding view images; a memory for storing ground record information on each record point, the ground record information including a ground image and position data of the record point, and fixture record information on one or more fixtures included in a surrounding view image captured at each record point, the fixture record information including feature data and position data of each fixture; and a processor for acquiring current position data of the pedestrian's current position, wherein the processor performs operations including: extracting object feature data, which is feature data of an object included in the surrounding view image; performing provisional positioning of the pedestrian based on the position data included in the fixture record information, by comparing the extracted object feature data with feature data of fixtures included in the fixture record information; based on a result of the provisional positioning, extracting some of the ground images stored in the memory as candidate ground images to be compared for matching; comparing each candidate ground image with an underfoot image provided from the downward camera, aiming to find a matching ground image to the underfoot image; and when a matching ground image is found in the candidate ground images, acquiring position data of the record point corresponding to the matching ground image as the pedestrian's current position data.

Another aspect of the present invention provides a positioning method for positioning a pedestrian device configured to acquire position data of a pedestrian's current position, the method comprising: causing a camera to capture images of road surfaces under a foot of a pedestrian, thereby sequentially producing underfoot images; causing another camera to capture images of at least one of a front field of view, a right field of view, a left field of view, and a rear field of view of the pedestrian, thereby sequentially producing surrounding view images; causing a memory to store ground record information on each record point, the ground record information including a ground image and position data of the record point, and fixture record information on one or more fixtures included in a surrounding view image captured at each record point, the fixture record information including feature data and position data of each fixture; and extracting object feature data, which is feature data of an object included in the surrounding view image; performing provisional positioning of the pedestrian based on the position data included in the fixture record information, by comparing the extracted object feature data with feature data of fixtures included in the fixture record information; based on a result of the provisional positioning, extracting some of the ground images stored in the memory as candidate ground images to be compared for matching; comparing each candidate ground image with an underfoot image provided from the camera, aiming to find a matching ground image to the underfoot image; and when a matching ground image is found in the candidate ground images, acquiring position data of the record point corresponding to the matching ground image as the pedestrian's current position data.

### Effect of the Invention

According to the present invention, when camera-captured images of road surfaces on which a pedestrian can move are used in positioning the pedestrian, the amount of data processing required for image matching can be reduced.

### BRIEF DESCRIPTION OF THE DRAWINGS

FIG. 1 is a diagram showing an overall configuration of a traffic safety assistance system according to a first embodiment of the present invention;

FIG. 2 is an explanatory diagram showing an outline of an image matching operation performed by a pedestrian terminal according to the first embodiment;

FIG. 3 is an explanatory diagram showing a status of preset record points according to the first embodiment;

FIG. 4 is an explanatory diagram showing an example of stored data in an image-position DB according to the first embodiment;

FIG. 5 is an explanatory diagram showing an outline of a provisional positioning operation performed by a pedestrian terminal according to the first embodiment;

FIG. 6 is a block diagram showing schematic configurations of s pedestrian terminal and a roadside device according to the first embodiment;

FIG. 7 is a flow chart showing an operation procedure of a pedestrian terminal 1 according to the first embodiment;

FIG. 8 is a flow chart showing an operation procedure of the pedestrian terminal 1 according to the first embodiment;

FIG. 9 is a flow chart showing an operation procedure of an in-vehicle terminal 2 according to the first embodiment;

FIG. 10 is a flow chart showing an operation procedure of a roadside device 3 according to the first embodiment;

FIG. 11 is a block diagram showing a schematic configuration of a pedestrian terminal according to a second embodiment of the present invention;

FIG. 12 is a flow chart showing an operation procedure of the pedestrian terminal according to the second embodiment;

FIG. 13 is a block diagram showing a schematic configuration of a pedestrian terminal according to a third embodiment of the present invention;

FIG. 14 is a flow chart showing an operation procedure of the pedestrian terminal according to the third embodiment;

FIG. 15 is a flow chart showing an operation procedure of the pedestrian terminal according to a first variant of the third embodiment; and

FIG. 16 is a flow chart showing an operation procedure of the pedestrian terminal according to a second variant of the third embodiment.

### DESCRIPTION OF THE PREFERRED EMBODIMENT(S)

A first aspect of the present invention made to achieve the above-described object is a pedestrian device comprising: a downward camera for capturing images of road surfaces under a foot of a pedestrian, thereby sequentially producing underfoot images; a lateral view camera for capturing images of at least one of a front field of view, a right field of view, a left field of view, and a rear field of view of the pedestrian, thereby sequentially producing surrounding view images; a memory for storing ground record information on each record point, the ground record information including a ground image and position data of the record point, and fixture record information on one or more fixtures included in a surrounding view image captured at each record point, the fixture record information including feature data and position data of each fixture; and a processor for acquiring current position data of the pedestrian's current position, wherein the processor performs operations including: extracting object feature data, which is feature data of an object included in the surrounding view image; performing provisional positioning of the pedestrian based on the position data included in the fixture record information, by comparing the extracted object feature data with feature data of fixtures included in the fixture record information; based on a result of the provisional positioning, extracting some of the ground images stored in the memory as candidate ground images to be compared for matching; comparing each candidate ground image with an underfoot image provided from the downward camera, aiming to find a matching ground image to the underfoot image; and when a matching ground image is found in the candidate ground images, acquiring position data of the record point corresponding to the matching ground image as the pedestrian's current position data.

In this configuration, provisional positioning is performed to extract candidate ground images from ground images of record points so that the candidate ground images can be compared with a pedestrian's underfoot image, and when a matching ground image to the underfoot image is found in the candidate ground images, position data of the record point corresponding to the matching ground image is acquired as the pedestrian's current position data. Thus, when camera-captured images of road surfaces on which a pedestrian can move (i.e., underfoot images and ground images) are used in positioning the pedestrian, the amount of data processing can be reduced.

A second aspect of the present invention is the pedestrian device of the first aspect, further comprising a receiver for receiving satellite positioning signals, wherein the processor acquires the fixture record information from other pedestrian devices based on position data acquired from the satellite positioning signals, and stores the acquired fixture record information in the memory.

In this configuration, the pedestrian device can acquire only fixture record information on fixtures within a nearby region required for provisional positioning based on position data acquired from satellite positioning signals.

A third aspect of the present invention is the pedestrian device of the first aspect, wherein the downward camera and the lateral view camera are comprised of a single 360-degree camera.

This configuration enables the pedestrian device to acquire a pedestrian's underfoot images and surrounding view images as necessary without increasing complexity of configuration of the device.

A fourth aspect of the present invention is the pedestrian device of the first aspect, wherein the processor can suspend the provisional positioning, and wherein, while suspending the provisional positioning, the processor sequentially calculates an amount of movement of the pedestrian, and then, based on the calculated amount of movement, extracts some of the plurality of ground images stored in the memory as the candidate ground images.

In this configuration, the pedestrian device can suspend provisional positioning, which requires the relatively large amount of data processing, and instead, perform calculation of an amount of movement of a pedestrian, which requires the relatively low amount of data processing, to extract candidate ground images, thereby reducing a processing load on the processor.

A fifth aspect of the present invention is the pedestrian device of the fourth aspect, wherein the processor acquires the amount of movement of the pedestrian by using at least one of a self-position estimation operation based on a pedestrian dead reckoning process; and a self-position estimation operation based on a surrounding view image produced by the lateral view camera.

In this configuration, the pedestrian device can acquire an amount of movement of a pedestrian only by performing a simple processing operation.

A sixth aspect of the present invention is the pedestrian device of the first aspect, wherein the processor performs operations including: repeatedly performing the provisional positioning of the pedestrian; storing a result of each round of the provisional positioning in the memory; determining, based on the pedestrian's surrounding view image, whether or not view blockage occurs in a field of view of the lateral view camera; and when determining that view blockage occurs in the field of view of the lateral view camera, acquiring a past result of the provisional positioning stored in the memory as the latest result of provisional positioning.

In this configuration, when view blockage occurs in a field of view of the lateral view camera, the pedestrian device can avoid using improper surrounding view images, thereby ensuring a secure acquisition of the pedestrian's current position data.

A seventh aspect of the present invention is the pedestrian device of the sixth aspect, wherein the processor can suspend the provisional positioning, and wherein, while suspending the provisional positioning, the processor sequentially calculates an amount of movement of the pedestrian, and then, based on the calculated amount of movement, extracts some of the plurality of ground images stored in the memory as the candidate ground images, wherein, when determining that view blockage occurs in a field of view of the lateral camera, the processor calculates a view blockage continuation period, which is a time period during which the view blockage continuously occurs, and wherein, when the view blockage continuation period is equal to or greater than a predetermined threshold value, the processor suspends the provisional positioning, and acquires the amount of movement of the pedestrian by using at least one of a self-position estimation operation based on a pedestrian dead reckoning process; and a self-position estimation operation based on a surrounding view image produced by the lateral view camera.

In this configuration, when view blockage occurs in a field of view of the lateral camera and the view blockage continuation period becomes long, the pedestrian device can properly acquire the pedestrian's current position data based on an amount of movement of the pedestrian.

An eighth aspect of the present invention is the pedestrian device of the sixth or seventh aspect, further comprising a communication device for performing wireless communications with at least one of an in-vehicle device mounted on a vehicle and a roadside device, wherein, when determining that view blockage occurs in a field of view of the lateral camera, the processor transmits a message concerning the occurrence of the view blockage to at least one of the in-vehicle device and the roadside device by wireless communications using the communication device.

In this configuration, the pedestrian device can notify an in-vehicle device in a vehicle that view blockage occurs in a surrounding view (e.g., a front field of view) of the pedestrian, thereby improving safety of the pedestrian and the vehicle.

A ninth aspect of the present invention is a positioning method for positioning a pedestrian device configured to acquire position data of a pedestrian's current position, the method comprising: causing a camera to capture images of road surfaces under a foot of a pedestrian, thereby sequentially producing underfoot images; causing another camera to capture images of at least one of a front field of view, a right field of view, a left field of view, and a rear field of view of the pedestrian, thereby sequentially producing surrounding view images; causing a memory to store ground record information on each record point, the ground record information including a ground image and position data of the record point, and fixture record information on one or more fixtures included in a surrounding view image captured at each record point, the fixture record information including feature data and position data of each fixture; and extracting object feature data, which is feature data of an object included in the surrounding view image; performing provisional positioning of the pedestrian based on the position data included in the fixture record information, by comparing the extracted object feature data with feature data of fixtures included in the fixture record information; based on a result of the provisional positioning, extracting some of the ground images stored in the memory as candidate ground images to be compared for matching; comparing each candidate ground image with an underfoot image provided from the camera, aiming to find a matching ground image to the underfoot image; and when a matching ground image is found in the candidate ground images, acquiring position data of the record point corresponding to the matching ground image as the pedestrian's current position data.

In this configuration, provisional positioning is performed to extract candidate ground images from ground images of record points so that the candidate ground images can be compared with a pedestrian's underfoot image, and when a matching ground image to the underfoot image is found in the candidate ground images, position data of the record point corresponding to the matching ground image is acquired as the pedestrian's current position data. Thus, when camera-captured images of road surfaces on which a pedestrian can move (i.e., underfoot images and ground images) are used in positioning the pedestrian, the amount of data processing can be reduced.

Embodiments of the present invention will be described below with reference to the drawings.

### First Embodiment

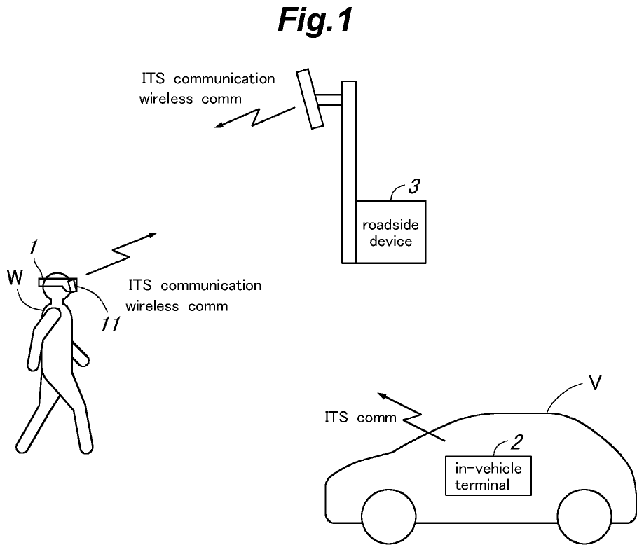

FIG. 1 is a diagram showing an overall configuration of a traffic safety assistance system according to a first embodiment of the present invention.

The traffic safety assistance system is configured to assist pedestrian and vehicle traffic safety and includes a pedestrian terminal 1 (pedestrian device), an in-vehicle terminal 2 (in-vehicle device), and a roadside device 3 (roadside device).

The pedestrian terminal 1, the in-vehicle terminal 2, and the roadside device 3 perform ITS communications with each other. ITS communications are performed using frequency bands adopted by ITS-based (i.e., using Intelligent Transport System) safe driving assistance wireless systems (for example, 700 MHz band or 5.8 GHz band). As used herein, “pedestrian-to-vehicle communications” refer to ITS communications performed between the pedestrian terminal 1 and the in-vehicle terminal 2, “roadside-to-pedestrian communications” refer to ITS communications performed between the pedestrian terminal 1 and the roadside device 3, and “roadside-to-vehicle communications” refer to ITS communications performed between the pedestrian terminal 1 and the roadside device 3. In addition, “vehicle-to-vehicle communications” refer to ITS communications performed between different in-vehicle terminals 2.

The pedestrian terminal 1 is carried by a pedestrian W; that is, a user of the terminal. The pedestrian terminal 1 transmits and receives messages including position data to and from the in-vehicle terminal 2 through ITS communications (pedestrian-to-vehicle communication). This enables the pedestrian terminal 1 to determine if there is a risk of collision between the pedestrian and the vehicle. When determining that there is such a risk of collision, the pedestrian terminal 1 provides an alert to the pedestrian W.

The in-vehicle terminal 2 is mounted in a vehicle. The in-vehicle terminal 2 transmits and receives messages including position data to and from the pedestrian terminal 1 through ITS communications (pedestrian-to-vehicle communication). This enables the in-vehicle terminal 2 to determine if there is a risk of collision between the pedestrian W and the vehicle V. When determining that there is such a risk of collision, the in-vehicle terminal 2 provides an alert to a driver. An alert is preferably provided by using a car component such as a car navigation device.

The roadside device 3 is installed at a place on or near a road, e.g., at an intersection. The roadside device 3 delivers various types of information, such as traffic information, to the pedestrian terminal 1 and the in-vehicle terminal 2 through ITS communications (roadside-to-pedestrian communications and roadside-to-vehicle communications). The roadside device 3 notifies the in-vehicle terminal 2 and the pedestrian terminal 1 that there are a vehicle V and a pedestrian W located near the roadside device 3 through ITS communications (roadside-to-vehicle communications, and roadside-to-pedestrian communications). This enables the vehicle V and the pedestrian W to prevent a collision at an intersection outside the line of sight.

The pedestrian terminal 1 is equipped with a camera 11 (a downward camera and a lateral view camera). The camera 11 is capable of generating a captured image of a road surface under a foot of a pedestrian W (hereinafter referred to as “an underfoot image”) and a captured image of a front field of view of the pedestrian W (hereinafter referred to as “a front field-of-view image”), the front field of view being a view seen by the pedestrian moving frontward. The camera can generate underfoot images and front field-of-view images as frame images that form a video (moving picture) at a predetermined frame rate. In the present embodiment, the camera 11 is provided integrally with a main body of the pedestrian terminal 1. However, the camera 11 may be provided separately from the main body of the pedestrian terminal 1 for convenience of shooting conditions (e.g., shooting direction and angle of view). In the latter case, the camera 11 is communicably connected to the main body of the pedestrian terminal 1 through wired or wireless communications.

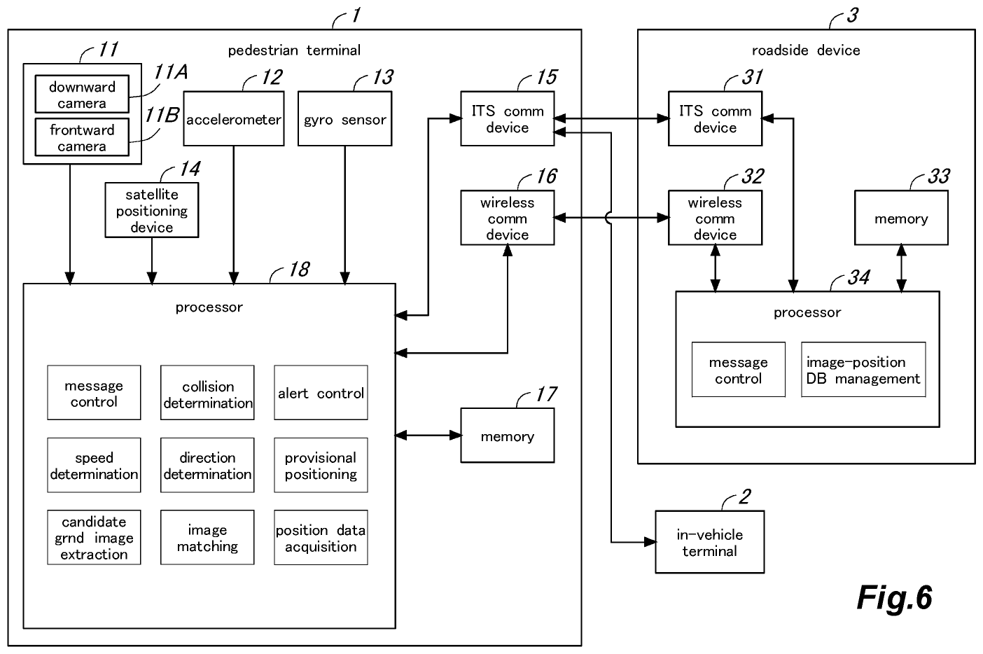

The camera 11 may include a plurality of cameras (see a downward camera 11A and a frontward camera 11B in FIG. 6) for generating underfoot images and front field-of-view images, respectively. In other cases, the camera 11 may be comprised of a single camera (e.g., a 360-degree camera) capable of capturing a wide area so that underfoot images and front field-of-view images (or equivalent images) can be generated. By using a single camera capable of capturing a wide area (which covers a required shooting area), the pedestrian terminal 1 is enabled to acquire underfoot images and front field-of-view images as necessary without increasing complexity of configuration of the terminal.

In the present embodiment, for explanatory convenience, the camera 11 generates an underfoot image produced by shooting a road surface under a foot of a pedestrian W and a front field-of-view image produced by capturing an image of a front field of view. In other embodiments, the camera 11 may produce an image of a view toward a different direction instead of a front field-of-view image. In other words, a lateral view camera such as the frontward camera 11B may be a camera configured to generate images of at least one of a front field of view, a right field of view, a left field of view, and a rear field of view of the pedestrian W (surrounding view images). For example, in order to protect privacy, the camera 11 may capture rear-facing images of the pedestrian W (images of a view toward the opposite direction of movement) instead of front-facing images of the pedestrian W. In other embodiments, the camera 11 may be configured with a single camera (e.g., a 360-degree camera) capable of capturing a wide area (e.g., a 360-degree camera) so that the camera can generate, in addition to underfoot images, images of at least one of a front field of view, a right field of view, a left field of view, and a rear field of view of the pedestrian, (or equivalent images). In such cases, the orientation (shooting direction) of the camera 11 does not need to be strictly aligned with either the front, rear, left or right direction of the pedestrian W.

In an example shown in FIG. 1, the pedestrian terminal 1 is a glasses-type wearable device (what is called “smart glasses”). The pedestrian terminal 1 is equipped with an AR display, which can display augmented reality (AR) implemented by overlaying virtual objects on the real space view of a user's actual field of vision. The AR display shows, as virtual objects, an image that indicate a risk of collision with vehicles and an image of a vehicle that is not directly visible to the pedestrian at an out-of-sight intersection. The pedestrian terminal 1 may be comprised of a plurality of separate components which can communicate with each other. For example, the pedestrian terminal 1 may be comprised primarily of a head-mounted part worn on a head of a pedestrian W and a separate body part carried on the pedestrian's body part other than the head.

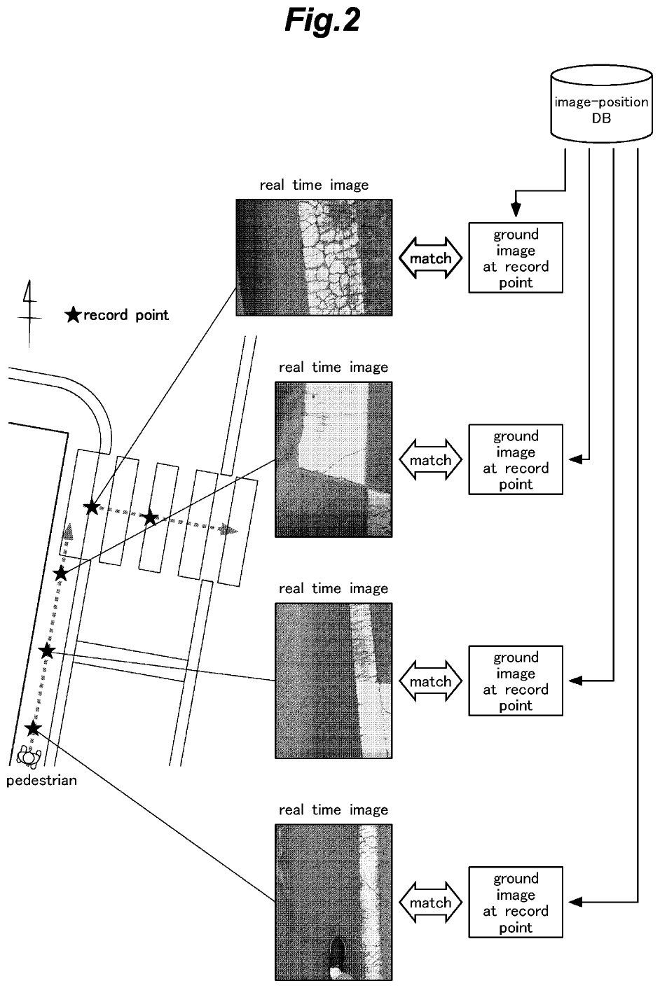

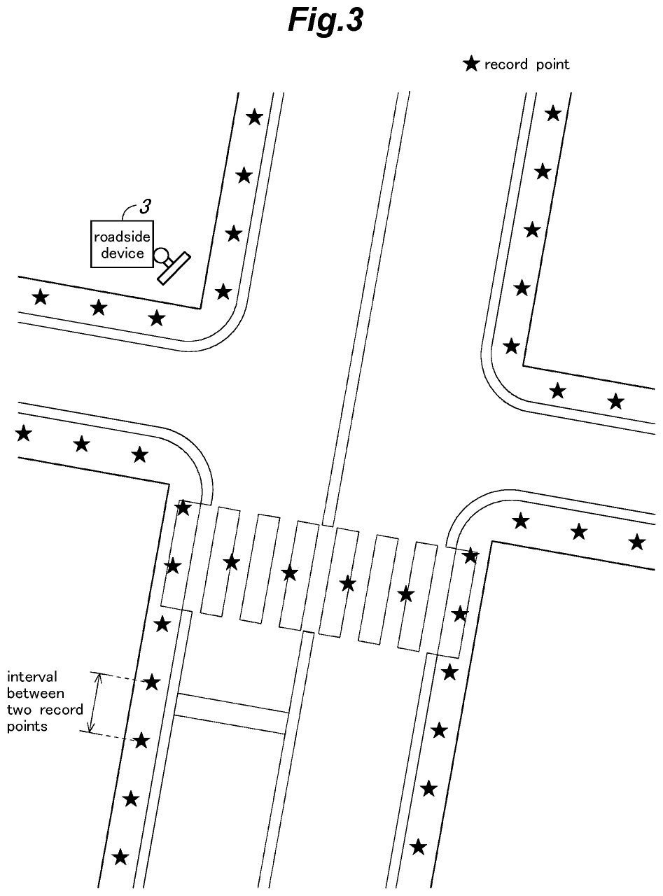

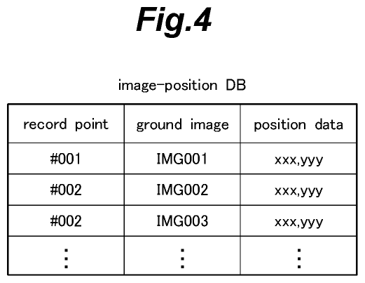

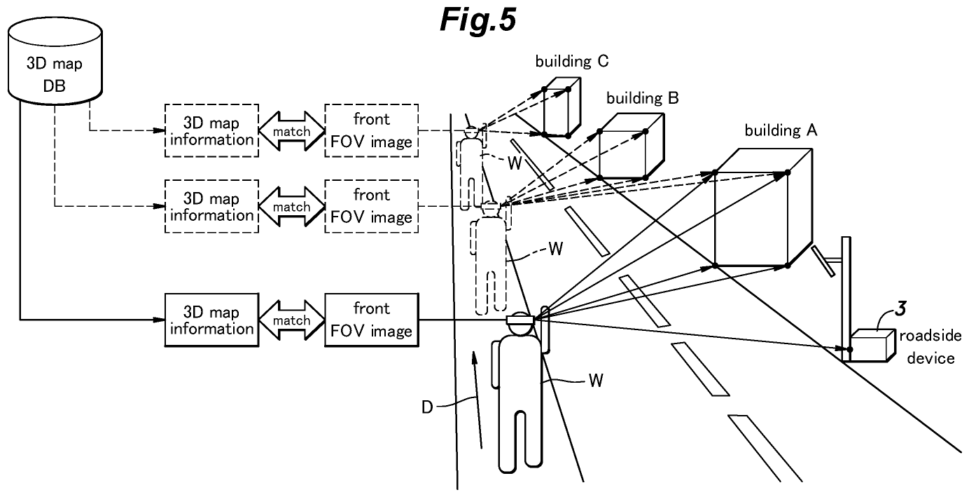

Next, an outline of an image matching operation performed by the pedestrian terminal 1 according to the first embodiment will be described. FIG. 2 is an explanatory diagram showing an outline of the image matching operation performed by the pedestrian terminal 1. FIG. 3 is an explanatory diagram showing an example of record points (As used herein, a record point refers to a preset point with a pre-shot ground image record), and FIG. 4 is an explanatory diagram showing an example of stored data in an image-position DB (database). FIG. 5 is an explanatory diagram showing an outline of a provisional positioning operation performed by a pedestrian terminal. Although embodiments of the present invention will be described with reference to a pedestrian terminal, the same technical ideas can be embodied in an in-vehicle terminal.

Road surfaces gradually deteriorate over time. For example, road surface markings such as white lines are painted on road surfaces using special paint (traffic paint), and cracks and other deterioration occur on the road markings over time. In addition, asphalt pavement material also deteriorates due to defects. The fact that these deteriorated road surfaces have unique characteristics at each location enables use of a captured ground image to identify a location (position) where the ground image was captured, based on the characteristics of the road surface.

In the present embodiment, an image-position DB (database) is prepared in the roadside device 3 beforehand such that the image-position DB contains, as ground record information, a captured image of a road surface (hereinafter referred to as “a ground image”) at each record point, in association with the position data of the record point (see FIG. 4). When the pedestrian terminal 1 is used, the camera 11 captures an image of a road surface under a foot of the pedestrian to output an underfoot image in real time. In addition, as shown in FIG. 2, the pedestrian terminal 1 performs an image matching operation; that is, the pedestrian terminal 1 compares a ground image of each record point in the image-position DB with the real time underfoot image provided from the camera 11 for matching, and when a matching ground image to a real time underfoot image is found, the pedestrian terminal 1 acquires the position data of the record point corresponding to the matching ground image as the position data of the pedestrian's current position.

In the present embodiment, as shown in FIG. 3, when the roadside device 3 is installed at an intersection, a target area for which the image-position DB contains data is a nearby area around the intersection at which the roadside device 3 is installed. More specifically, the target area is an area including the intersection where the roadside device 3 is installed and a predetermined range of each road segment connected to the intersection. Record points are preset within this target area such that adjoining pairs of record points are located at predetermined intervals (e.g., 25 cm). Since pedestrians usually pass through a pedestrian crossing at the intersection, or move down on sidewalks or roadside strips of the roads connected to the intersection, record points are preset in such roads (i.e., walking path) where pedestrians are likely to pass through.

Thus, as shown in FIG. 2, while a pedestrian is walking to pass through a pedestrian crossing at an intersection or on a sidewalk or roadside strip, the camera 11 periodically outputs a real time underfoot image, an image of a road surface under the pedestrian's feet, and the pedestrian terminal 1 performs the image matching operation using the real time underfoot image. When the pedestrian reaches a record point and a matching ground image is found there, the pedestrian terminal 1 can identify the current position of the pedestrian based on the position data of the record point corresponding to the matching ground image.

The pedestrian terminal 1 can perform the image matching operation, which enables determination of a moving direction of a pedestrian (i.e., the direction in which the pedestrian is moving). Specifically, when the image-position DB contains the orientation of the captured image, for example, the orientation of the upper side of the captured image (east, west, north, or south), the pedestrian terminal 1 performs the image matching operation to thereby rotate the captured image in the image-position DB so as to match the orientation of the captured image to that of the real time underfoot image provided from the camera 11, thereby determining the orientation of the upper side of the real time underfoot image; that is, the pedestrian's moving direction.

In the image matching operation, if a number of (or all) ground images recorded in the image-position DB are used as candidate ground images to be compared with a real-time underfoot image for matching, rapid data processing (real-time data processing) can become difficult to be done. Thus, before the image matching operation, the pedestrian terminal 1 performs a candidate ground image extraction operation; that is, the pedestrian terminal 1 extracts ground images that are more suitable to be compared for matching (hereinafter referred to as “candidate ground images”) from the ground images stored in the image-position DB.

In the candidate ground image extraction operation, the pedestrian terminal 1 performs provisional positioning of the pedestrian W. As a result, the pedestrian terminal 1 acquires rough position data of the current position of the pedestrian W (hereinafter referred to as “provisional positioning information”). Generally, provisional positioning result data is less accurate than position data acquired by performing the image matching operation.

In the present embodiment, 3D map information (fixture record information) is recorded in a 3D map DB (database) prepared beforehand on a cloud computing platform. The 3D map information includes feature information on fixtures (constructions such as buildings and bridges) in captured images of surrounding views around points on a pedestrian's walking path (surrounding view images). Specifically, the 3D map information includes, for each fixture included in surrounding view images, information records of features of the fixture e, i.e., feature data of the fixture (e.g., multiple feature points of the shape thereof) and position data of the fixture. The pedestrian terminal 1 extracts feature data of each object (multiple feature points of the shape of each object, the object including fixtures such as buildings and bridges) in a front field-of-view image output in real time from the camera 11. Then, the pedestrian terminal 1 performs provisional positioning of the pedestrian by comparing the extracted feature data of the object with that of fixtures included in the 3D map information for matching. In performing such provisional positioning, the pedestrian terminal 1 can use known technologies such as Area Learning and VPS (Visual Positioning Service).

In the example shown in FIG. 5, the pedestrian W moves in the direction indicated by an arrow D. When the pedestrian reaches a point where the camera 11 can capture a building A (object) as a fixture, the pedestrian terminal 1 performs provisional positioning of the pedestrian W by comparing a plurality of feature points (indicated by black points in the figure) of the building A included in the real-time front field-of-view image with those included in the 3D map information. Then, based on a provisional positioning result (i.e., provisional positioning result data), the pedestrian terminal 1 determines a provisionally identified current position of the terminal device (i.e., the position of the pedestrian W) and extracts ground images (images of road surfaces) captured at points near the provisionally identified current position as candidate ground images.

Before extraction of candidate ground images, the pedestrian terminal 1 can acquire partial pieces of the 3D map information (fixture record information) recorded in the 3D map DB on the cloud computing platform and store the acquired information in the memory of the terminal. In a preferred embodiment, after receiving and using satellite positioning signals to determine rough position data of the current position of the pedestrian W, the pedestrian terminal 1, based on the rough position data of the pedestrian W, retrieves only pieces of the 3D map information required for provisional positioning (i.e., information on a nearby area around the pedestrian W from the 3D map DB). This method shortens a time required for the pedestrian terminal 1 to acquire 3D map information and reduces data volume of 3D map information required to be stored in the memory of the pedestrian terminal 1. The 3D map DB from which the pedestrian terminal 1 acquires 3D map information may be stored in any other device (e.g., a server or any other computer) that can communicate with the pedestrian terminal 1 via a communication network.

Furthermore, as the pedestrian W moves, the real-time front field-of-view image output from the camera 11 will include buildings B and C as fixtures. The pedestrian terminal 1 can perform provisional positioning of the pedestrian W using these fixtures one by one, based on a plurality of feature points (indicated by black points in the figure) of the buildings B and C included in the real-time front field-of-view images in the same manner as the above-described case of the building A.

A place where the 3D map information is held is not limited to the 3D map DB created on the cloud computing platform, and the 3D map information may be stored in the memory of a roadside device 3 located near the walking path. In this case, each roadside device 3 only needs to store 3D map information on a nearby area around the device.

The pedestrian terminal 1 may be configured to perform a preliminary image matching operation, which includes: (i) predicting the record point where the pedestrian is to reach next based on the position data of a past position of the pedestrian (e.g., the previous record point where the image matching operation was performed or the position of the pedestrian acquired by the previous provisional positioning) and the pedestrian's movement status determined based on detection results of an accelerometer 12 and a gyro sensor 13 (see FIG. 6); (ii) extracting one or more ground images to be subjected to an image matching operation from those in the image-position DB based on the prediction result, and (iii) comparing each extracted underfoot image with the real time underfoot image output from the camera 11 for matching (i.e., searching for a matching ground image to a real time underfoot image).

In one embodiment, the pedestrian terminal determines, as the pedestrian's movement status, the pedestrian's moving direction based on the detection results of the gyro sensor 13, and the pedestrian's moving speed based on the detection results of the accelerometer 12; and then predicts the next record point which the pedestrian is to reach, based on the pedestrian's moving direction and moving speed. In other embodiments, the pedestrian terminal may predict the next record point the pedestrian is to reach based only on the pedestrian's moving direction. In this case, the record point located ahead of the pedestrian's moving direction is selected as a predicted next record point that the pedestrian is to reach.

The preliminary image matching operation described above includes predicting the next record point where the pedestrian is to reach based on the pedestrian's movement status. In other embodiments, the pedestrian terminal may perform a pedestrian dead reckoning (PDR) operation to estimate the pedestrian's current position, and predict the next record point the pedestrian is to reach based on the estimated position.

Use of the preliminary image matching operation enables fast execution of the image matching operation, and also enables reduction of a processing load on a processor when performing the image matching operation.

Next, schematic configurations of a pedestrian terminal 1 and a roadside device 3 according to the first embodiment will be described. FIG. 6 is a block diagram showing schematic configurations of a pedestrian terminal 1 and a roadside device 3.

The pedestrian terminal 1 includes a camera 11, an accelerometer 12, a gyro sensor 13, a satellite positioning device 14, an ITS communication device 15, a wireless communication device 16, a memory 17, and a processor 18.

The camera 11 is provided with a downward camera 11A for capturing images under a foot of a pedestrian, and a frontward camera 11B for capturing images of a front field of view of the pedestrian.

The accelerometer 12 detects an acceleration of the pedestrian's body. The gyro sensor 13 detects the angular velocity of the pedestrian's body. The pedestrian terminal 1 may be further provided with other motion sensors.

The satellite positioning device 14 includes a receiver for receiving satellite positioning signals for a satellite positioning system such as GPS (Global Positioning System) or QZSS (Quasi-Zenith Satellite System). The satellite positioning device 14 determines the position of the pedestrian terminal 1 based on the received satellite positioning signals to thereby acquire the position data (latitude, longitude) of the pedestrian terminal 1.

The ITS communication device 15 broadcasts (delivers) messages to an in-vehicle terminal 2 and a roadside device 3 through ITS communications (vehicle-to-vehicle and road-to-vehicle communications), and also receives messages transmitted from the in-vehicle terminal 2 and the roadside device 3.

The wireless communication device 16 transmits and receives messages to and from the roadside device 3 through wireless communications such as WiFi (Registered Trademark). The ITS communication device 15 and the wireless communication device 16 each have known hardware such as antennas and communication circuits for communications with other devices.

The memory 17 stores map data, programs executable by the processor 18, and other information. In the present embodiment, the memory 17 stores ground record information contained in the image-position DB, i.e., a ground image and position data for each record point. The memory 17 also stores 3D map information acquired from the 3D map DB, i.e., feature data and position data of fixtures such as buildings located around points on the pedestrian's walking path. Moreover, in the present embodiment, when approaching an intersection, the pedestrian terminal 1 acquires, from a roadside device 3 installed at the intersection, the ground record information in the image-position DB for the nearby area around the intersection. A 3D map DB may be created on a roadside device 3, so that the pedestrian terminal 1 can acquire 3D map information in the 3D map DB which only contains 3D map information on a nearby area from the roadside device 3.

The processor 18 performs various processing operations by executing the programs stored in the memory 17. In the present embodiment, the processor 18 performs a message control operation, a collision determination operation, an alert control operation, a speed determination operation, a direction determination operation, a provisional positioning operation, a candidate ground image extraction operation, an image matching operation, and a position data acquisition operation. The pedestrian terminal 1 may execute various processing operations by using multiple processors. The pedestrian terminal 1 may also have another information processing device execute some of the above-described processing operations and then acquire operations results from the device.

In the message control operation, the processor 18 controls the transmission of messages through ITS communications (hereafter also written as “ITS communication messages”) between the in-vehicle terminal 2 and the roadside device 3. The processor 18 also controls the transmission of messages through wireless communications (hereafter also written as “wireless communication messages”) between the pedestrian terminal 1 and the roadside device 3.

In the collision determination operation, the processor 18 determines whether or not there is a risk of collision between a vehicle and the pedestrian based on the vehicle position data included in the vehicle information acquired from the in-vehicle terminal 2, and the pedestrian position data acquired by the satellite positioning device 14.

In the alert control operation, the processor 18 controls provision of a prescribed alert (e.g., voice output or vibration) to the pedestrian when determining that there is a risk of collision in the collision determination operation.

In the speed determination operation, the processor 18 determines the pedestrian's moving speed based on the detection results of the accelerometer 12. When a pedestrian walks, the pedestrian's walking force produces acceleration on the pedestrian's body, and the processor 18 can determines the walking pitch (duration for a complete footstep) of the pedestrian based on the change of the acceleration. Then, the processor 18 calculates the moving speed from the pedestrian's walking pitch and stride length. The stride length may be determined based on the attribute of the pedestrian (such as adult or child) stored in the pedestrian terminal 1.

In the direction determination operation, the processor 18 determines the pedestrian's moving direction based on the detection results of the gyro sensor 13.

In the provisional positioning operation, the processor 18 compares feature data of each object in a real-time front field-of-view image output from the frontward camera 11B with feature data of fixtures such as buildings in the 3D map information for matching. The processor 18 acquires provisional positioning result data based on the matching results.

In the candidate ground image extraction operation, the processor 18 extracts, based on the provisional positioning result data, candidate ground images that are suitable to be compared with the real-time underfoot image for matching from the captured ground images stored in the image-position DB. More specifically, the processor 18 acquires rough position data of the current position of the pedestrian, and extracts ground images contained in the ground record information on record points around the pedestrian's current position as candidate ground images.

In the candidate ground image extraction operation, the processor 18 may predict the record point where the pedestrian is to reach next based on the pedestrian's past position, moving speed, and moving direction, and extract candidate ground images based on the prediction result.

In the image matching operation, the processor 18 compares the candidate ground images extracted during the candidate ground image extraction operation, with a real time underfoot image provided from the camera 11 for matching. Specifically, the processor 18 extracts feature data (information on feature points) from both the real time underfoot image and the candidate ground images, respectively, and compares each feature data with a corresponding feature data for matching, to thereby find a matching ground image to a real time underfoot image. In some cases, the processor 18 may perform the image matching operation using AI (artificial intelligence) technology.

In the position data acquisition operation, the processor 18 acquires the position data of a record point corresponding to a matching ground image found in the image matching operation, as the position data of the pedestrian's current position.

The in-vehicle terminal 2 also includes a processor and a memory (not shown), and is capable of performing a message control operation, a collision determination operation, and an alert control operation by executing programs stored in the memory.

The roadside device 3 includes an ITS communication device 31, a wireless communication device 32, a memory 33, and a processor 34.

The ITS communication device 31 broadcasts (delivers) messages to a pedestrian terminal 1 and an in-vehicle terminal 2 through ITS communications (road-to-pedestrian and road-to-vehicle communications), and also receives messages transmitted from the pedestrian terminal 1 and the in-vehicle terminal 2.

The wireless communication device 32 transmits and receives messages to and from the pedestrian terminal 1 through wireless communications such as WiFi (Registered Trademark). The ITS communication device 31 and the wireless communication device 32 each have known hardware such as antennas and communication circuits for communications with other devices.

The memory 33 stores programs that are executable by the processor 34, and other information. In the present embodiment, the memory 33 stores ground record information in the image-position DB (see FIG. 4). The memory 33 may store 3D map information (fixture record information) in a 3D map database DB).

The processor 34 performs various processing operations by executing the programs stored in the memory 33. In the present embodiment, the processor 34 performs a message control operation and an image-position DB management operation.

In the message control operation, the processor 34 controls the transmission of ITS communication messages between the pedestrian terminal 1 and the in-vehicle terminal 2. The processor 34 also controls the transmission of wireless communication messages between the pedestrian terminal 1 and the roadside device 3.

In the image-position DB management operation, the processor 34 manages the image-position DB (see FIG. 4). The image-position DB contains a camera-captured image and position data for each record point. In the present embodiment, such record information in the image-position DB is delivered to the pedestrian terminal 1 upon request from the pedestrian terminal 1.

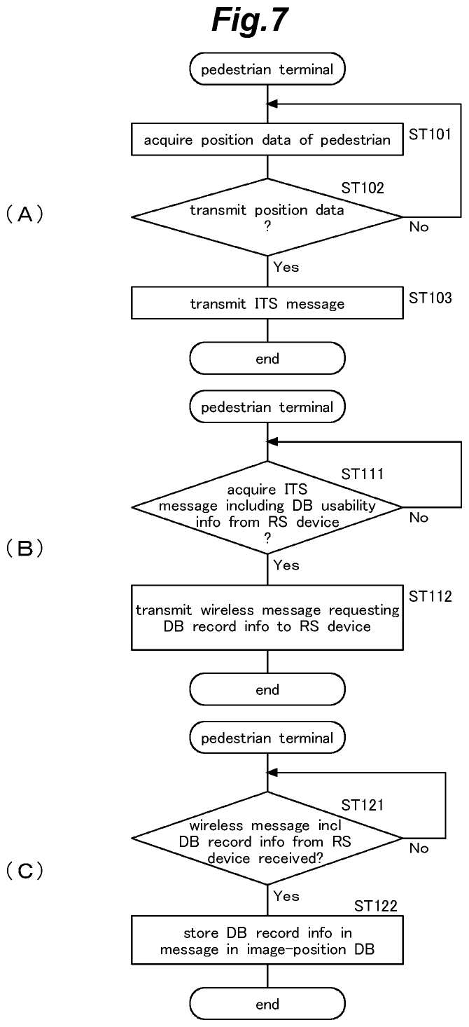

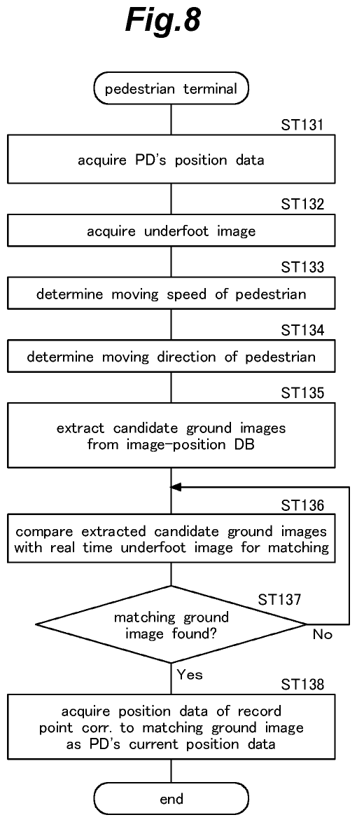

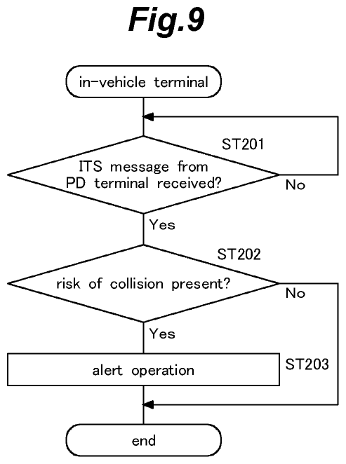

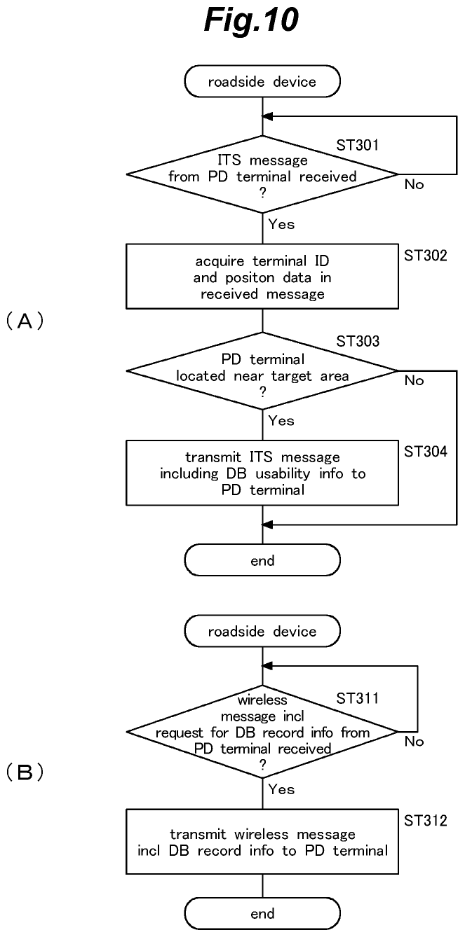

Next, operation procedures of the pedestrian terminal 1, the in-vehicle terminal 2, and the roadside device 3 of the first embodiment will be described. FIGS. 7 and 8 are flow charts showing operation procedures of the pedestrian terminal 1. FIG. 9 is a flow chart showing an operation procedure of the in-vehicle terminal 2. FIG. 10 is a flow chart showing an operation procedure of the roadside device 3.

As shown in FIG. 7(A), in the pedestrian terminal 1, the satellite positioning device 14 first acquires a pedestrian's position data (ST101). Next, the processor 18 determines, based on the pedestrian's position data, whether or not pedestrian information should be transmitted, specifically, whether or not a user has entered a dangerous area (ST102).

When pedestrian information should be transmitted to other devices (Yes in ST102), in response to a transmission instruction provided from the processor 18, the ITS communication device 15 transmit an ITS communication message containing the pedestrian information (such as pedestrian's ID and position data) to the in-vehicle terminal 2 and the roadside device 3 (ST103).

As shown in FIG. 9, when the in-vehicle terminal 2 receives the ITS communication message (through pedestrian-to-vehicle communications) from the pedestrian terminal 1 (Yes in ST201), the in-vehicle terminal 2 performs the collision determination operation based on the position data of the vehicle and other information included in the message, to thereby determine whether or not there is a risk that the vehicle may collide with a pedestrian (ST202).

When determining that there is a risk of collision (Yes in ST202), the in-vehicle terminal 2 performs a predetermined alert operation for a driver (ST203). Specifically, the in-vehicle terminal 2 causes an in-vehicle navigation system to provide an alert (e.g., sound output or screen display) to the driver. When the vehicle is an autonomous vehicle, the in-vehicle terminal 2 instructs an autonomous driving ECU (travel control device) to perform a predetermined collision avoidance operation.

As shown in FIG. 10(A), in the roadside device 3, when the ITS communication device 31 receives an ITS communication message (through vehicle-to-pedestrian communications) from the pedestrian terminal 1 (Yes in ST301), the processor 34 acquires the terminal ID and position data of the pedestrian terminal 1 included in the received message (ST302). Next, the processor 34 determines, based on the pedestrian's position data, whether or not the pedestrian terminal 1 is located near a target area (within or around the target area), for which the image-position DB contains record information (ST303).

When determining that the pedestrian terminal 1 is located near the target area (Yes in ST303), the processor 34 provides a transmission instruction, causing the ITS communication device 31 to transmit an ITS communication message including DB usability information to the pedestrian terminal 1, where the DB usability information indicates that the recorded information in the image-position DB in the roadside device 3 is usable by the pedestrian terminal 1 (ST304).

As shown in FIG. 7(B), in the pedestrian terminal 1, when the ITS communication device 15 receives the ITS communication message including DB usability information from the roadside device 3 (Yes in ST111), the processor 18 provides a transmission instruction, causing the wireless communication device 16 to transmit a wireless communication message requesting DB record information (record information in the image-position DB) to the roadside device 3 (ST 112). The DB record information may contain 3D map information stored in the 3D map DB.

As shown in FIG. 10(B), in the roadside device 3, when the wireless communication device 32 receives the wireless communication message requesting DB record information from the pedestrian terminal 1 (Yes in ST311), the processor 34 provides a transmission instruction, causing the wireless communication device 32 to transmit a wireless communication message including DB record information to the pedestrian terminal 1 (ST312).

In this step, the roadside device 3 may transmit all record information in the image-position DB to the pedestrian terminal 1, or transmit only part of record information that is likely to be used by the pedestrian terminal 1, to the pedestrian terminal 1. Specifically, the roadside device 3 may transmit record information associated with record points within a predetermined area near the pedestrian terminal 1, in particular the record points within a predetermined range located along the path in the pedestrian's moving direction.

As shown in FIG. 7(C), in the pedestrian terminal 1, when the wireless communication device 16 receives the wireless communication message including DB record information from the roadside device 3 (Yes in ST121), the processor 18 stores the DB record information (record information in the image-position DB) included in the received message, in the database of the pedestrian terminal 1 (ST122).

Next, as shown in FIG. 8, in the pedestrian terminal 1, the processor 18 acquires the position data of the pedestrian's position (ST131). The pedestrian terminal 1 provides, as a result of provisional positioning, the pedestrian's position data (provisional positioning result data). More specifically, the processor 18 extracts feature data of an object contained in the real time image of the front field of view provided from the camera 11, and compares each feature data with that of a fixture such as a building include in the 3D map information for matching to acquire position data (position data of an absolute position) of the pedestrian. In step ST131, instead of performing provisional positioning, the processor 18 may acquire position data of a pedestrian based on the received satellite positioning signals. The pedestrian's position data acquired in step ST131 is sequentially stored in the memory 17.

In some cases, the pedestrian terminal 1 may acquire part of the 3D map information which is required for provisional positioning, recorded in the 3D map DB on the cloud computing platform and store the acquired information in a database in the terminal 1.

The processor 18 also acquires a real time underfoot image, an image of a road surface under the pedestrian's foot captured by the camera 11 (ST132). Such real time underfoot images are repeatedly acquired at predetermined time intervals. Furthermore, the processor 18 determines the moving speed of the pedestrian based on the detection results of the accelerometer 12 (ST133), and determines the pedestrian's moving direction (traveling direction) based on the detection results of the gyro sensor 13 (ST134).

Next, based on a pedestrian's position data (i.e., position data of a provisionally determined current position) acquired in step ST131, the processor 18 performs a candidate ground image extraction operation (ST135); that is, extracts candidate ground images to be compared with the acquired real time underfoot image acquired in step ST132.

More precisely, in step ST 135, the processor 18 can extract, as candidate ground images, ground images of record points located within a predetermined distance from the provisionally determined current position of the pedestrian. In this case, the processor 18 may restrict candidate ground images to be extracted to those of record points located generally in the front and rear directions of the pedestrian (the directions of moving direction and the opposite direction).

Next, the processor 18 performs an image matching operation; that is, compares a candidate ground image extracted from the image-position DB with the real time underfoot image provided from the camera 11 for matching (ST136).

In step ST135, the processor 18 may predict the record point where the pedestrian is to reach next (predicted record point) based on the position data of a past position of the pedestrian (e.g., the pedestrian's position acquired by the previous provisional positioning), and the speed of movement, and the direction of movement, and extract candidate ground images based on the prediction result. As a result, in step ST139, when the pedestrian reaches the predicted record point, the processor 18 can compare the extracted candidate ground images with the real time underfoot image provided from the camera 11 for matching (preliminary image matching operation).

When an image matching operation is successfully completed; that is, when a matching ground image to the real image underfoot image is found in the candidate ground images (Yes in ST137), then the processor 18 performs a position data acquisition operation to acquire position data of the record point corresponding to the matching ground image, as the position data of the pedestrian's current position (ST138). The pedestrian terminal 1 can repeat the above-described steps ST131-ST138.

In the present embodiment, the roadside device 3 provides a ground image of a record point to the pedestrian terminal 1, which performs the image matching operation. In other embodiments, the roadside device 3 may transmit feature data (information on feature points) extracted from a ground image of a record point, to the pedestrian terminal 1. In this case, the pedestrian terminal 1 performs the image matching operation by comparing the feature data of the record point transmitted from the roadside device 3 with the corresponding feature data extracted from the real time image. In other cases, the roadside device 3 may cut out a feature part of the ground image of the record point and provide the feature part image to the pedestrian terminal 1, so that the pedestrian terminal 1 can perform the image matching operation using the feature part image. This configuration decreases the amount of information records in the image-position DB that is required to be transmitted from the roadside device 3 to the pedestrian terminal 1, thereby enabling reduction in the amount of data processing required for wireless communications between the roadside device 3 and the pedestrian terminal 1.

In some cases, the system may be configured such that all communication links between the roadside device 3 and the pedestrian terminal 1 are those for cellular communications and all the functions of a roadside device 3 are stored in the cloud, which enables management of an image-position DB for a wider area.

As described above, the pedestrian terminal 1 compares candidate ground images extracted based on a result of provisional positioning, with a real time underfoot image for matching, and when a matching ground image to the underfoot image is found, the pedestrian terminal 1 acquires position data of the record point corresponding to the matching ground image as the pedestrian's current position data. Thus, when camera-captured images of road surfaces on which a pedestrian can move (i.e., underfoot images and ground images) are used in positioning the pedestrian, the amount of data processing to be performed by the processor 18 can be reduced.

### Second Embodiment

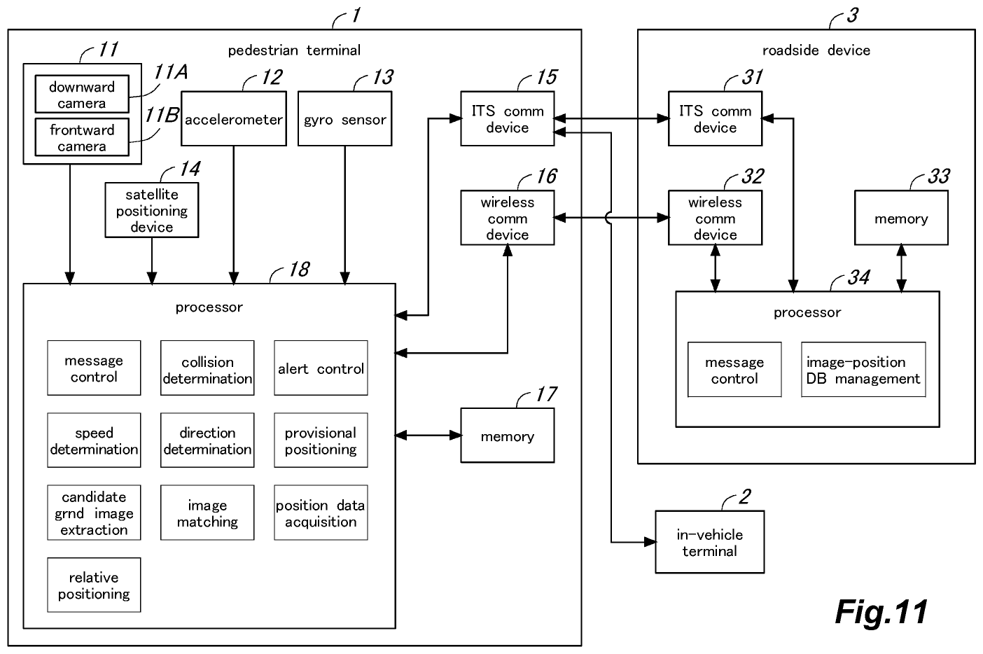

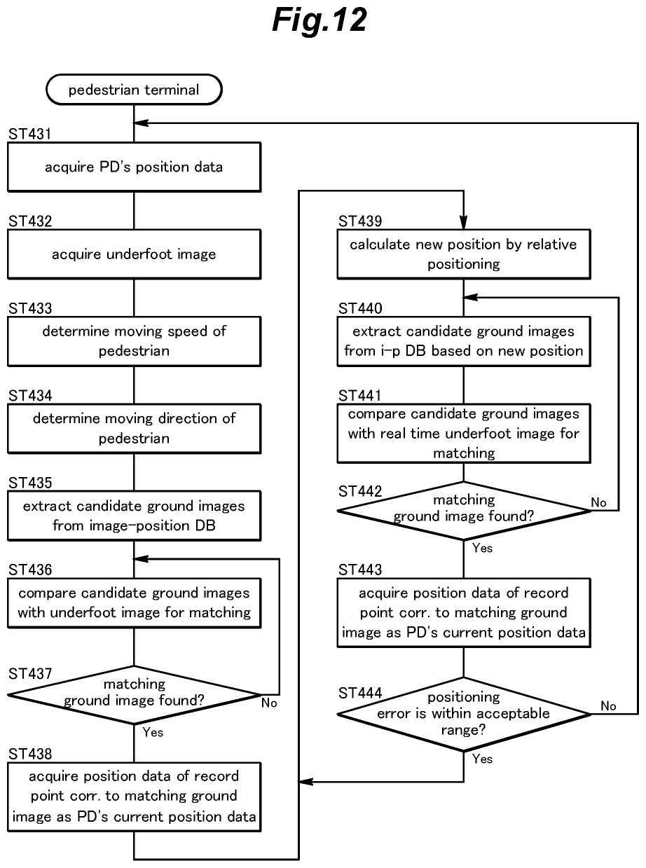

Next, a traffic safety assistance system according to a second embodiment of the present invention will be described. FIG. 11 is a block diagram showing a schematic configuration of a pedestrian terminal 1 according to the second embodiment. FIG. 12 is a flow chart showing an operation procedure of the pedestrian terminal 1 according to the second embodiment. Except for what will be discussed below, the second embodiment is the same as the first embodiment. In the description of the second embodiment, the same features or elements as those of the first embodiment are denoted with same reference numerals without repeating the description thereof.

In the second embodiment, as shown in FIG. 11, a processor 18 performs a relative positioning operation; that is, an operation for acquiring a relative position (hereinafter referred to as “relative positioning”) in addition to the operations performed in the first embodiment. In the relative positioning operation, pedestrian dead reckoning (PDR) technique using the accelerometer 12 and the gyro sensor 13 is utilized, and the processor 18 sequentially calculates an amount of movement from a pedestrian's reference position (in this case, the most recent pedestrian's position acquired by the position data acquisition operation), and adds up the amounts of movement to thereby acquire position data of the pedestrian's current position. In other cases, utilizing known Visual SLAM (Simultaneous Localization and Mapping) technique in the relative positioning operation, the processor 18 may perform a self-position estimation and an environment map preparation using the camera 11 (a frontward camera 11B), to sequentially calculate an amount of movement from the pedestrian's reference position.

In the second embodiment, as shown in FIG. 12, the processor 18 performs operations in steps ST431 to ST438, i.e., operations for acquiring an absolute position (hereinafter referred to as “absolute positioning”) that are similar to steps ST131 to ST138 shown in FIG. 8, respectively. In the absolute positioning, the processor acquires position data of a pedestrian's current position by repeating a provisional positioning operation (absolute positioning), which results in a relatively high data processing load on the processor 18.

To address this problem, in the second embodiment, the processor 18 suspends absolute positioning as long as a positioning error is within a predetermined range, and, while suspending absolute positioning, performs relative positioning, which can be performed with a relatively low data processing load on the processor 18, to acquire the position data of a pedestrian's current position.

In the relative positioning, the processor 18 first calculates an amount of movement and a moving direction of a pedestrian from the pedestrian's reference position by the relative positioning operation, and uses the calculated amount of movement and moving direction as bases to acquire position data of the pedestrian's current position (ST439). With regard to the pedestrian's reference position, immediately after suspending the absolute positioning, the pedestrian's current position acquired in step ST438 is used as a reference position of the pedestrian, and subsequently, a position calculated by the previous relative positioning is used as the reference position.

Next, based on the new position data acquired in step ST439, the processor 18 extracts candidate ground images to be compared with the real-time underfoot image (ST440) in a similar manner to the candidate ground image extraction operation in step ST436. In this way, while suspending the provisional positioning to acquire an absolute position, the processor 18 can sequentially calculate an amount of movement and a moving direction of the pedestrian and perform provisional positioning based on the calculation results of the amount of movement and the moving direction, to thereby extract some of the ground images stored in the memory as candidate ground images.

Next, the processor 18 compares the candidate ground images extracted from those in the database of the pedestrian terminal, with the latest underfoot image provided from the camera 11 for matching (ST441).

When the image matching operation is successfully completed (Yes in ST442), the processor 18 performs the position data acquisition operation, acquiring the position data of a record point corresponding to a matching ground image found in the image matching operation, as the position data of the pedestrian's current position (ST443).

Then, the processor 18 determines whether a positioning error; an error of a measurement acquired by relative positioning, is within an acceptable range, and when the positioning error is within the acceptable range (Yes in ST444), the process returns to step ST439, and the processor 18 continues relative positioning. When the e positioning error in the relative positioning exceeds the acceptable range (No in ST444), the process returns to step ST431, and the processor 18 terminates relative positioning and starts absolute positioning again.

### Third Embodiment

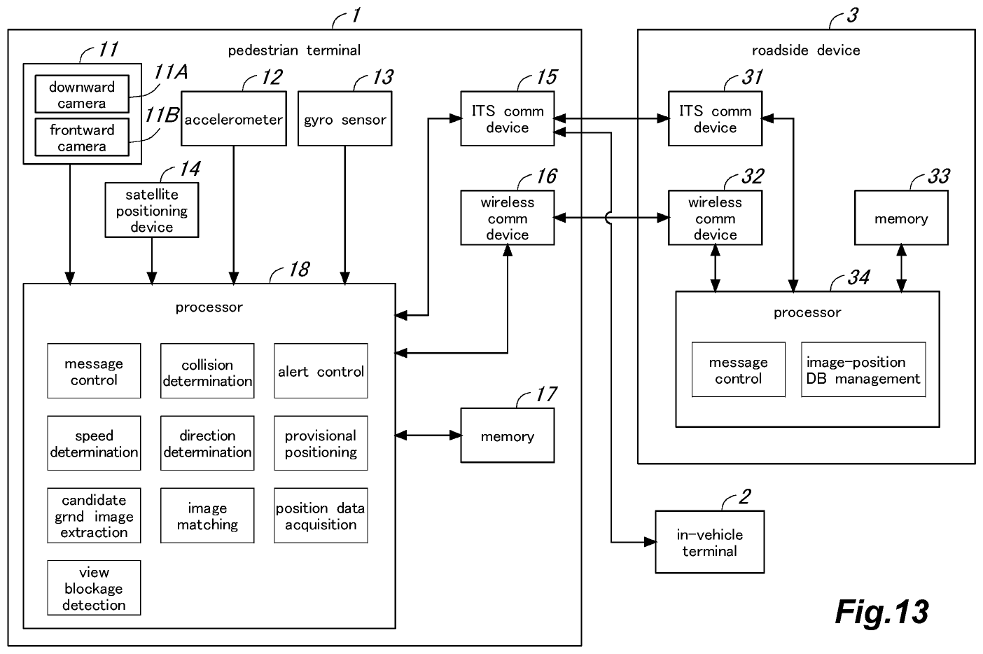

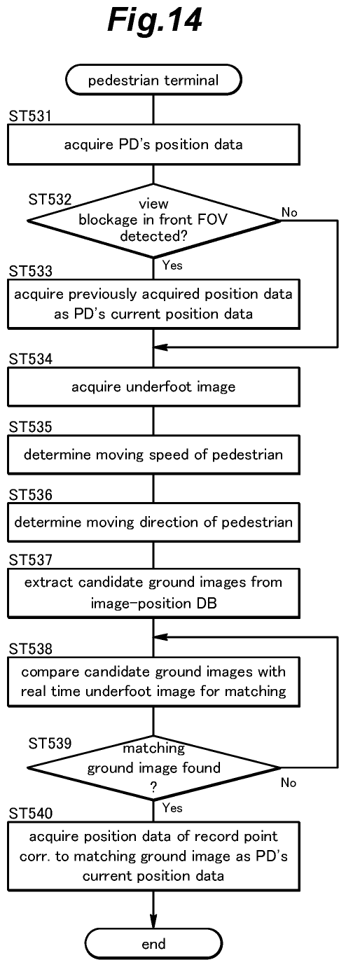

Next, a traffic safety assistance system according to a third embodiment of the present invention will be described. FIG. 13 is a block diagram showing a schematic configuration of a pedestrian terminal according to the third embodiment of the present invention. FIG. 14 is a flow chart showing an operation procedure of the pedestrian terminal according to the third embodiment. Except for what will be discussed below, the third embodiment is the same as the first and second embodiments. In the description of the third embodiment, the same features or elements as those of the first and second embodiments are denoted with same reference numerals without repeating the description thereof.

In the third embodiment, as shown in FIG. 13, a processor 18 performs a view blockage detection operation in addition to the operations performed in the first embodiment. In the view blockage detection operation, the processor 18 determines whether or not view blockage occurs in a (front) field of view of the frontward camera 11B. In this configuration, when view blockage occurs in a front field of view of the frontward camera 11B, the pedestrian terminal can avoid using improper front field-of-view images, thereby ensuring a secure acquisition of the pedestrian's current position data.

In the third embodiment, as shown in FIG. 14, the processor 18 acquires position data of a pedestrian (ST531) in a similar manner to the step ST131 shown in FIG. 8. Then, the processor 18 performs the view blockage detection operation to detect whether or not view blockage occurs in the field of view of the frontward camera 11B. When detecting the occurrence of view blockage (Yes in ST532), the processor 18 acquires the pedestrian's position data acquired in the previous step ST531 as the current position data of the pedestrian (i.e., the latest provisional positioning result) (ST533). As a result, when view blockage occurs in a (front) field of view of the frontward camera 11B, the pedestrian terminal can avoid using improper front field-of-view images, thereby ensuring a secure acquisition of the pedestrian's current position data.

In some cases, the processor 18 may be configured such that, when failing to acquire position data of the pedestrian or acquiring abnormal position data in step ST531, the processor 18 determines that view blockage of the frontward camera 11B occurs in step ST532. In other cases, the processor 18 may be configured such that, when detecting a blocking object (e.g., an object that can interfere with the execution of operations such as Area Learning, VPS) in a field-of-view image by using known techniques, the processor 18 determines that view blockage in a front field of view of the frontward camera 11B occurs.

Then, the processor 18 performs operations in steps ST534-ST540, which are similar to steps ST132-ST138 shown in FIG. 8, respectively.

When a panorama camera (360-degree camera) is used as the camera 11, in step ST531, the processor 18 uses a part (an image area) of an image captured by the panorama camera as a front field-of-view image. In step ST534, the processor 18 uses a part (an image area) of an image captured by the panorama camera as an underfoot image.

When detecting occurrence of view blockage in step ST532 (Yes in ST532), the process returns to step ST531, and the pedestrian terminal 1 may acquire, as a surrounding view image, an image (or a part of the image) of a field of view towards a direction which is different from the frontward direction of the pedestrian where the image of the field of view is not affected by the view blockage seen in the front field of view. In this case, the step ST533 can be skipped. The above-described panorama camera can be applied to other embodiments and variations of embodiments of the present invention in a similar manner.

### First Variant of Third Embodiment

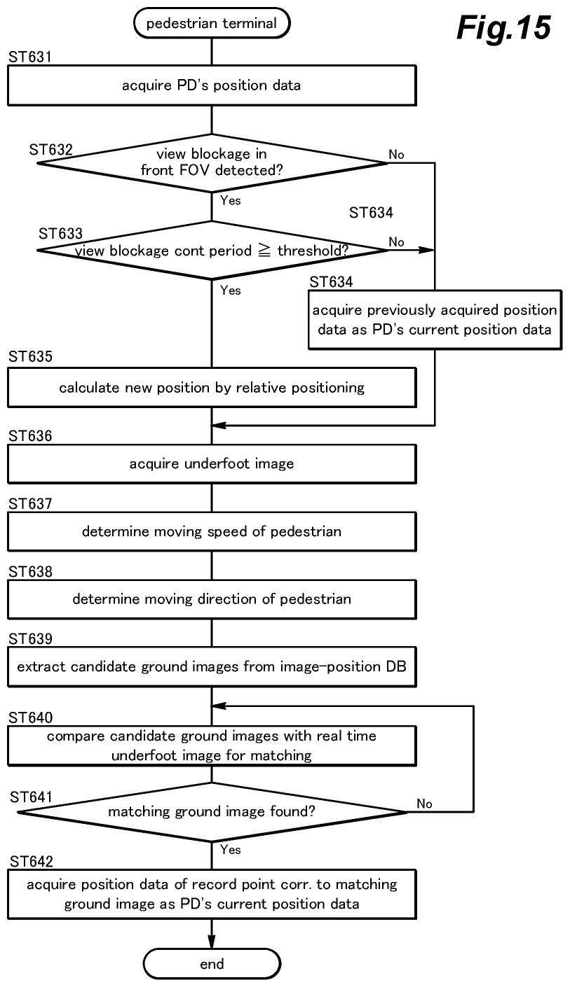

Next, a traffic safety assistance system according to a first variant of the third embodiment of the present invention will be described. FIG. 15 is a flow chart showing an operation procedure of the pedestrian terminal according to the first variant of the third embodiment. Except for what will be discussed below, the first variant is the same as the third embodiment. In the description of the first variant, the same features or elements as those of the third embodiment are denoted with same reference numerals without repeating the description thereof.

In the first variant, as shown in FIG. 15, the processor 18 acquires position data of a pedestrian and determines whether or not view blockage occurs in a front field-of-view image captured by the frontward camera (ST631 and ST632), in a similar manner to steps ST531 and ST532 shown in FIG. 14. When detecting the occurrence of view blockage in the front field-of-view image (Yes in ST632), the processor 18 determines whether a view blockage continuation period, which is a time period during which the view blockage continuously occurs, is equal to or greater than a predetermined threshold value (ST633).

When determining that the view blockage continuation period is less than the predetermined threshold value (No in ST633), the processor 18 acquires position data of a pedestrian that was successfully acquired in the previous operation in step ST631 as the position data of the pedestrian in the same manner as in step ST533 of FIG. 14 (ST634). When determining that the view blockage continuation period is equal to or greater than the threshold value (Yes in ST633), the processor 18 acquires new position data of the pedestrian's current position by calculating the pedestrian's movement from a reference position by relative positioning, as in step ST439 in FIG. 12 (ST635). The point used as the reference position of a pedestrian is, when relative positioning in step ST635 is first performed, the position of the pedestrian acquired in the previous step ST634, and thereafter the new position calculated by the previous relative positioning.

Then, the processor 18 performs the operations of steps ST636 to ST642, which are similar to steps ST534 to ST540 shown in FIG. 14, respectively. In this way, when the view blockage continuation period in the field of view of the frontward camera 11B becomes long, position data of a pedestrian's current position can be properly acquired based on the pedestrian's movement. Moreover, the processor 18 can perform the candidate ground image extraction operation of step ST639 by using either position data acquired in step ST634 or that acquired in ST635 depending on a result of the determination of whether or not the view blockage continuation period is equal to or greater a predetermined threshold value (ST633).

### Second Variant of Third Embodiment

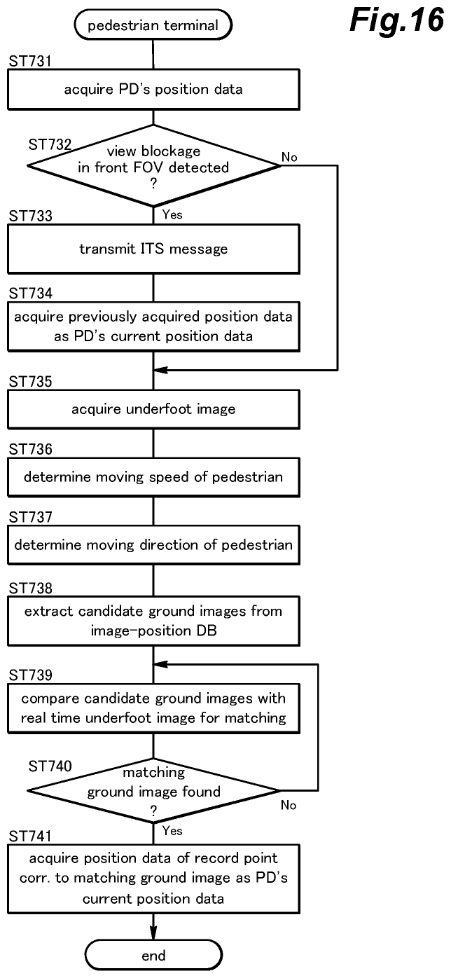

Next, a traffic safety assistance system according to a second variant of the third embodiment of the present invention will be described. FIG. 16 is a flow chart showing an operation procedure of the pedestrian terminal according to the second variant of the third embodiment. Except for what will be discussed below, the first variant is the same as the third embodiment. In the description of the first variant, the same features or elements as those of the third embodiment are denoted with same reference numerals without repeating the description thereof.

In the second variant, as shown in FIG. 16, the processor 18 acquires position data of a pedestrian and determines whether or not view blockage occurs in a front field of view of the frontward camera (ST731 and ST732), in a similar manner to steps ST531 and ST532 in FIG. 14. When detecting the occurrence of view blockage in the front field of view (Yes in ST732), the processor 18 causes the ITS communication device 15 to transmit an ITS communication message including a pedestrian's information (e.g., pedestrian ID and position data) to a vehicle and a roadside device through pedestrian-to-vehicle communications and roadside-to-pedestrian communications, respectively (ST 733). As a result, the processor 18 can notify the vehicle and the roadside device that view blockage occurs in a front view of the pedestrian, thereby improving safety of the pedestrian and the vehicle.

While specific embodiments of the present invention are described herein for illustrative purposes, the present invention is not limited to those specific embodiments. It will be understood that various changes, substitutions, additions, and omissions may be made to elements of the embodiments without departing from the scope of the invention. In addition, elements and features of the different embodiments may be combined with each other to yield an embodiment of the present invention.

### INDUSTRIAL APPLICABILITY

A pedestrian device and a positioning method according to the present invention have an effect of enabling positioning of a pedestrian by using camera-captured images of road surfaces on which the pedestrian moves, with a reduced data processing load on a data processing device, and are useful as a pedestrian device that is carried by a pedestrian and performs a positioning operation to acquire position data of the pedestrian, and a positioning method for the same

### GLOSSARY

1 pedestrian terminal (pedestrian device)
2 in-vehicle terminal (in-vehicle device)
3 roadside device
11 camera
11A downward camera
11B frontward camera
12 accelerometer
13 gyro sensor
14 satellite positioning device
15 ITS communication device
16 wireless communication device
17 memory
18 processor
31 IT'S communication device
32 wireless communication device
33 memory
34 processor

1. A pedestrian device comprising:
a downward camera for capturing images of road surfaces under a foot of a pedestrian, thereby sequentially producing underfoot images;
a lateral view camera for capturing images of at least one of a front field of view, a right field of view, a left field of view, and a rear field of view of the pedestrian, thereby sequentially producing surrounding view images;
a memory for storing ground record information on each record point, the ground record information including a ground image and position data of the record point, and fixture record information on one or more fixtures included in a surrounding view image captured at each record point, the fixture record information including feature data and position data of each fixture; and
a processor for acquiring current position data of the pedestrian's current position,
wherein the processor performs operations including:
extracting object feature data, which is feature data of an object included in the surrounding view image;
performing provisional positioning of the pedestrian based on the position data included in the fixture record information, by comparing the extracted object feature data with feature data of fixtures included in the fixture record information;
based on a result of the provisional positioning, extracting some of the ground images stored in the memory as candidate ground images to be compared for matching;
comparing each candidate ground image with an underfoot image provided from the downward camera, aiming to find a matching ground image to the underfoot image; and
when a matching ground image is found in the candidate ground images, acquiring position data of the record point corresponding to the matching ground image as the pedestrian's current position data.

2. The pedestrian device as claimed in claim 1, further comprising a receiver for receiving satellite positioning signals,
wherein the processor acquires the fixture record information from other pedestrian devices based on position data acquired from the satellite positioning signals, and stores the acquired fixture record information in the memory.

3. The pedestrian device as claimed in claim 1, wherein the downward camera and the lateral view camera are comprised of a single 360-degree camera.

4. The pedestrian device as claimed in claim 1, wherein the processor can suspend the provisional positioning, and
wherein, while suspending the provisional positioning, the processor sequentially calculates an amount of movement of the pedestrian, and then, based on the calculated amount of movement, extracts some of the plurality of ground images stored in the memory as the candidate ground images.

5. The pedestrian device as claimed in claim 4, wherein the processor acquires the amount of movement of the pedestrian by using at least one of a self-position estimation operation based on a pedestrian dead reckoning process; and a self-position estimation operation based on a surrounding view image produced by the lateral view camera.

6. The pedestrian device as claimed in claim 1, wherein the processor performs operations including:
repeatedly performing the provisional positioning of the pedestrian;
storing a result of each round of the provisional positioning in the memory;
determining, based on the pedestrian's surrounding view image, whether or not view blockage occurs in a field of view of the lateral view camera; and
when determining that view blockage occurs in the field of view of the lateral view camera, acquiring a past result of the provisional positioning stored in the memory as the latest result of provisional positioning.

7. The pedestrian device as claimed in claim 6, wherein the processor can suspend the provisional positioning, and
wherein, while suspending the provisional positioning, the processor sequentially calculates an amount of movement of the pedestrian, and then, based on the calculated amount of movement, extracts some of the plurality of ground images stored in the memory as the candidate ground images,
wherein, when determining that view blockage occurs in a field of view of the lateral camera, the processor calculates a view blockage continuation period, which is a time period during which the view blockage continuously occurs, and
wherein, when the view blockage continuation period is equal to or greater than a predetermined threshold value, the processor suspends the provisional positioning, and acquires the amount of movement of the pedestrian by using at least one of a self-position estimation operation based on a pedestrian dead reckoning process; and a self-position estimation operation based on a surrounding view image produced by the lateral view camera.

8. The pedestrian device as claimed in claim 6, further comprising a communication device for performing wireless communications with at least one of an in-vehicle device mounted on a vehicle and a roadside device,
wherein, when determining that view blockage occurs in a field of view of the lateral camera, the processor transmits a message concerning the occurrence of the view blockage to at least one of the in-vehicle device and the roadside device by wireless communications using the communication device.

9. A positioning method for positioning a pedestrian device configured to acquire position data of a pedestrian's current position, the method comprising:
causing a camera to capture images of road surfaces under a foot of a pedestrian, thereby sequentially producing underfoot images;
causing another camera to capture images of at least one of a front field of view, a right field of view, a left field of view, and a rear field of view of the pedestrian, thereby sequentially producing surrounding view images;
causing a memory to store ground record information on each record point, the ground record information including a ground image and position data of the record point, and fixture record information on one or more fixtures included in a surrounding view image captured at each record point, the fixture record information including feature data and position data of each fixture; and
extracting object feature data, which is feature data of an object included in the surrounding view image;
performing provisional positioning of the pedestrian based on the position data included in the fixture record information, by comparing the extracted object feature data with feature data of fixtures included in the fixture record information;
based on a result of the provisional positioning, extracting some of the ground images stored in the memory as candidate ground images to be compared for matching;
comparing each candidate ground image with an underfoot image provided from the camera, aiming to find a matching ground image to the underfoot image; and
when a matching ground image is found in the candidate ground images, acquiring position data of the record point corresponding to the matching ground image as the pedestrian's current position data.
